(19) United States
(12) Patent Application Publication
(10) Pub. No.: US 2021/0088255 A1
(43) Pub. Date: Mar. 25, 2021

(54) CONCENTRATING SOLAR POWER MODULE

(71) Applicant: Alexander Levin, Binyamina (IL)

(72) Inventor: Alexander Levin, Binyamina (IL)

(21) Appl. No.: 16/576,064

(22) Filed: Sep. 19, 2019

(51) Int. Cl. F24S 23/74; F24S 80/453; F24S 50/20

(52) U.S. Cl. CPC F24S 23/74; F24S 50/20; F24S 80/453

(57) ABSTRACT

This invention relates to concentrating solar power systems with application of parabolic dish-shaped reflectors.

A proposed CSP module applies a two-phase thermosiphon intended to transport heat generated by concentrated sunlight on a sunlight receiver onto the external surface of a heat exchanging pipe. The outer end butt of a distal plug, which seals the lower section of the two-phase thermosiphon, is provided with a sunlight absorbing coating.

A tracking manipulator is installed below a dish-shaped mirror and joined with its supporting structure; it provides orientation of the axis of the dish-shaped mirror towards the sun.

The walls of the two-phase thermosiphon are provided with a metal vacuum insulated jacket, which has a flexible middle sub-section of its lower section.

Design of the middle and distal sub-sections of the lower section of the two-phase thermosiphon allows accompanied orientation of the distal sub-section axis of the two-phase thermosiphon towards the sun.

### BACKGROUND OF THE INVENTION

This invention relates to concentrating solar power systems (CSP) and, particularly, to CSP with application of parabolic dish-shaped reflectors.

All concentrating solar power (CSP) technologies use a mirror configuration to concentrate the sun's light energy onto a receiver and convert it into heat. The heat can then be used to create steam to drive a turbine to produce electrical power or used as industrial process heat.

Concentrating solar power plants can integrate thermal energy storage systems to use to generate electricity during cloudy periods or for hours after sunset or before sunrise. This ability to store solar energy makes concentrating solar power a flexible and dispatchable source of renewable energy.

CSP systems can be also combined with combined cycle power plants resulting in hybrid power plants which provide high-value, dispatchable power. They can also be integrated into existing thermal-fired power plants that use a power block like CSP; such as coal, natural gas, biofuel or geothermal plants.

CSP plants can also use fossil fuel to supplement the solar output during periods of low sunlight.

There are four types of CSP technologies, with the earliest in use being trough, and the fastest growing being tower. For each of these, there are various design variations or different configurations, depending on whether thermal energy storage is included, and what methods are used to store solar thermally. In a parabolic trough CSP system, the sun's energy is concentrated by parabolically curved, trough-shaped reflectors onto a receiver pipe running along about a meter above the curved surface of the mirrors. The temperature of the heat transfer fluid flowing through the pipe, usually thermal oil, is increased from 293° C. to 393° C., and the heat energy is then used to generate electricity in a conventional steam generator.

A collector field comprises multiple parabolic trough-shaped mirrors in parallel rows aligned to enable single-axis trough-shaped mirrors to track the sun from east to west during the day to ensure that the sun is continuously focused on the receiver pipes.

A power tower or central receiver systems utilize sun-tracking mirrors called heliostats to focus sunlight onto a receiver at the top of a tower. A heat transfer fluid heated in the receiver up to around 600° C. is used to generate steam, which, in turn, is used in a conventional turbine-generator to produce electricity.

A parabolic dish system consists of a parabolic-shaped point focus concentrator in the form of a dish that reflects sunlight onto a receiver mounted at the focal point. These concentrators are mounted on a structure with a two-axis tracking system to follow the sun. The collected heat is typically utilized directly by a heat engine mounted on the receiver moving with the dish structure. Stirling and Brayton cycle engines are currently favored for power in a power block, or generate steam for direct use.

US Patent Application No. 20070283949 to the author of this invention discloses a solar radiation collector, which is designed as the combination of a concentrated solar radiation receiver, a single-curvature or compound-curvature concentrator and a tracking mechanism.

The present invention of the author is an attempt of further development of the technical solutions proposed in US Patent Application No. 20070283949 for a compound-curvature concentrator in the form of a parabolic dish.

There are some drawbacks of CSP system on the base of parabolic trough mirrors, a few of which are listed below.

1. Concentrated sunlight illuminates only a part of the whole surface of the sunlight receiving pipe; at the same time, heat loss by IR radiation occurs from the entire outer surface of this pipe.

2. Sealing the metal pipe of the receiver with the glass envelope is very expensive and complicated from the technological point of view.

3. It is impossible to insulate thermally the sunlight receiving pipe in a modular manner.

4. Low strength of the glass envelope does not permit this glass envelope to be used as a carrying element of the construction of a solar collector.

Therefore, it is important to develop solar collectors on the base of compound-curvature reflectors (dish-shaped mirrors) with absence of these drawbacks.

There are some US patents related to the area of this invention, none of which completely solve the above problems.

U.S. Pat. No. 4,048,982 describes a bulb-type solar energy collector comprising a hollow glass body shaped with a parabolic interior surface that is coated with specular finish of a metal, e.g. silver, and includes an apex aperture and integral hollow yoke. A hollow glass, bulb-shaped absorber element is exteriorly coated with a wave length selective coating. The bulb-shaped element includes a tubular hollow stem dependent from the bulbar portion and fixed in the yoke of the glass body so that the central axis of the stem and bulbar end portion is along the focal axis of the parabolic reflecting surface. A cover plate is sealed over the enlarged end of the reflecting surface enclosing the interior mirror surface in a chamber which is evacuated to substantial vacuum, e.g. 10.sup.-4 torr or greater vacuum. A working liquid is circulated from a source in a manifold through the interior volume of the absorber element to remove the solar energy absorbed thereby as heat and the media is returned to the manifold. The solar energy laden liquid is available for heating, cooling or power generating uses.

This US Patent does not teach any technical solution of tracking the reflector after the sun motion.

U.S. Pat. No. 10,094,595 discloses a solar heat collector, which comprises: a continuous sheet of radially-symmetric solar reflectors, each of the solar reflectors having a focal point and configured such that each reflector redirects light impinging at any point along a surface of the reflector to the focal point; and tubing routing heat absorbing fluid through the focal points of at least some of the solar reflectors in series along a continuous path and through the focal points of at least some of the solar reflectors in parallel, wherein the tubing has an input tube for receiving the heat absorbing fluid and an output tube for outputting heated heat absorbing fluid and wherein the sheet is flexible such that it may be rolled or folded.

US Patent Application No. 20150184894 describes a system and apparatus which is designed to use parabolic concentrator to focus sunlight onto a receiver which uses a coolant to carry the heat to the heat storage unit. The system comprises a primary loop comprising at least one solar array and at least one heat storage unit.

The system further comprises a secondary loop operatively communicating with said primary loop. The solar array comprises plurality of reflector dish assemblies comprising reflector dish means whereby said dish means are arranged in close proximity to each other wherein said dish means being such that high sunlight concentration ratio is obtained for providing high conversion efficiency from heat to electricity.

U.S. Pat. No. 4,340,031 describes a solar energy concentrating collector having a concave paraboloid reflector surface supported on a plurality of segments, said segments being parabolically-shaped on the top edge and extending radially from a circle near the central axis of revolution to the periphery, and arranged to contact with a reference means which is equidistant from the central axis at all points of revolution. The reference means may be a protrusion contacting with a cutout or other indentation on the bottom edge of a semi-parabolic shaped support whereby to insure accurate placement of reflector components for high focusing accuracy after assembly.

There are some articles and materials of ACT (Advanced Cooling Technologies) Company (USA) regarding applications of high temperature heat pipes.

Application of high temperature heat pipes for solar collectors is noted in Jan F. Kreider “Medium and High Temperature Solar Processes” ACADEMIC PRESS New York San Francisco London 1979 pp. 83-85.

Detailed description of high temperature two-phase thermosiphons is presented in the book: V. I. Tolubinsky and E. N. Shevchuk ‘HIGH TEMPERATURE HEAT PIPES”, Kiev, Naukova Dumka 1989 (in Russian).

### BRIEF SUMMARY OF THE INVENTION

A CSP (concentrating solar power) module of this invention is based on usage of a two-phase thermosiphon intended to transport heat generated by concentrated sunlight on a sunlight receiving member to the external surface of a pipe with flowing heat transfer fluid (HTF). The outer end butt of a distal plug, which seals the lower section of the two-phase thermosiphon, is provided with a sunlight absorbing coating playing a role of the receiving member.

The lower section of the two-phase thermosiphon is divided onto three sub-sections: a distal sub-section from a pipe, a middle sub-section designed as a bellows and a proximal sub-section from another pipe.

The proximal sub-section of the lower section of the two-phase thermosiphon is in fluid communication via a 3-way connector with two upper sections of the two-phase thermosiphon; these upper sections are designed as two inclined pipes. It should be noted that term “3-way connector” relates in this invention to a specific shape of an unit section and this shape can be obtained by different fabrication technologies.

A heat exchanging member, which is designed as a heat exchanging pipe, is positioned in the internal space of two inclined pipes of the upper sections and the 3-way connector of the two-phase thermosiphon; the ends of the heat exchanging pipe are protruded from the inclined pipes of the upper section and these ends are provided with inlet and outlet connections.

The proximal ends of the inclined pipes are sealingly joined with the heat exchanging pipe. In such a way, the upper section of the two-phase thermosiphon is designed similarly as a tube-in-tube heat exchanger.

The walls of the two-phase thermosiphon are provided with a metal vacuum insulated jacket with sub-sections corresponded to the sub-sections of the lower and upper sections of the two-phase thermosiphon; the middle sub-section of the lower section of the metal vacuum insulated jacket is a bellows, which is situated around the bellows of the lower section of the two-phase thermosiphon. The proximal ends of an upper section of the metal vacuum insulated jacket are sealingly joined with the proximal sub-sections of the inclined pipes of the two-phase thermosiphon.

There are two posts with supporting members, which support the proximal sub-sections of the upper sections of the metal vacuum insulated jacket.

A metal funnel with a flanging of its lower edge is installed on the distal sub-section of the lower section of the metal vacuum insulated jacket; a glazing is installed on the flanging of the metal funnel.

The outer surface of the metal funnel can be provided with a layer of thermal insulation. The internal surface of the metal funnel has preferably high reflecting coefficient for solar irradiation.

In another version a metal cylinder with a flanging on its lower edge can be applied instead of the metal funnel.

The internal space between the metal vacuum insulated jacket and the two-phase thermosiphon can be filled with fibers, microporous materials or refractories (or fire clays) in order to decrease heat losses caused by electromagnetic irradiation.

There is a bushing, which is fastened on the distal sub-section of the lower section of the metal vacuum insulated jacket; this bushing is joined by truss struts with a supporting structure of a parabolic dish-shaped mirror. The supporting structure is joined in turn with a tracking manipulator at a certain point of this supporting structure. The tracking manipulator provides orientation of the axis of the parabolic dish-shaped mirror and, therefore, of the axis of the distal sub-section of the lower section of the two-phase thermosiphon and the distal sub-section of the lower section of the metal vacuum insulated jacket towards the sun.

The tracking manipulator can operate on the base of a celestial tracking algorithm or with application of optical detectors, which determine direction of the axis of the parabolic dish-shaped mirror regarding the sun.

The tracking manipulator comprises in general two mechanisms of mutually perpendicular displacements in the horizontal plane and a mechanism of vertical displacement; an arm of the tracking manipulator, which is joined with the supporting structure of the parabolic dish-shaped mirror at a certain spot, causes by combination of these three displacements desired azimuthal and altitude parameters of the axis of the parabolic dish-shaped mirror (these displacements depend as well on geometric and mechanical characteristics of the bellows of the two-phase thermosiphon and the bellows of the metal vacuum insulated jacket).

The outer surfaces of the bellows of the two-phase thermosiphon and of the metal vacuum insulated jacket can be protected by braids.

The upper sections of the two-phase thermosiphon and/or the metal vacuum insulated jacket can be provided with auxiliary bellows in order to compensate tensions caused by the temperature differences between them, and between them and the heat exchanging member.

The internal end butt of the distal plug of the two-phase thermosiphon can be covered with capillary coating in order to ensure uniform wetting of the internal end butt of the distal plug and to achieve higher heat transfer characteristics.

The external end butt of this distal plug is provided with the sunlight absorbing coating as it was noted above, preferably, with a selective coating with high sunlight absorbing coefficient (above 0.8) in the visible spectrum of sunlight and low emissivity (less 0.5) in infrared range of electromagnetic radiation.

The internal walls of the heat exchanging pipe sections can be provided with longitudinal ribs. Such pipes are produced, for example, by Osaka Steel Tube Co. (Japan). In addition, a significant part of the heat exchanging pipe can be helically coiled.

These both versions allow to apply the proposed CSP module for direct superheated steam generation, or for heating to high temperatures a gaseous flowing medium.

It should be noted that the two-phase thermosiphon can operate with sodium, potassium, cesium, rubidium or their alloys applied as a heat transfer working fluid; these and other metals with sufficiently low melting and boiling points and their vapors fill the internal space of the two-phase thermosiphon.

Several other heat transfer working fluid can be applied: water, dowtherm A, some metal halides.

In another version of the two-phase thermosiphon design its upper section comprises an upper pipe having concave axis; a heat exchanging pipe of smaller diameter has a concave axis too and is situated coaxially in the internal space of the upper section of the two-phase thermosiphon.

The terminal sections of this heat exchanging pipe with its inlet and outlet connections are protruded from the upper pipe of the two-phase thermosiphon and the ends of the upper pipe are sealingly joined with the proximal sections of the heat exchanging pipe.

A metal vacuum insulated jacket surrounds the walls of the two-phase thermosiphon.

### BRIEF DESCRIPTION OF THE SEVERAL VIEWS OF THE DRAWINGS

FIG. 1a shows a concentrating solar power (CSP) module, which comprises a two-phase thermosiphon (its axial cross-section) serving for transportation of heat generated on a coating, which absorbs concentrated sunlight; this coating covers the external end butt of a distal plug sealing the lower section the two-phase thermosiphon.

The proximal sub-section of the lower section of the two-phase thermosiphon is in fluid communication via a 3-way connector with two inclined upper sections of the two-phase thermosiphon; these inclined upper sections are designed as two inclined pipes.

A heat exchanging member, which is designed as a heat exchanging pipe, is positioned in the internal spaces of two inclined upper sections and the 3-way connector of the two-phase thermosiphon; inlet and outlet connections of the heat exchanging member are protruded from the sealings of the proximal ends of the inclined pipes of the upper sections of the two-phase thermosiphon.

A metal vacuum insulated jacket surrounds the walls of the two-phase thermosiphon.

The proximal sub-sections of the upper section of the metal vacuum insulated jacket are supported by two supporting member fastened on two posts.

A glazing is installed on the flanging of the metal funnel. The internal surface of the metal funnel can be provided with a coating with high reflectance coefficient for sunlight.

The lower section of the metal vacuum insulated jacket of the two-phase thermosiphon is joined with a supporting structure of a parabolic dish-shaped mirror by a bushing installed on the distal sub-section of this lower section of the metal vacuum insulated jacket and by truss struts.

The supporting structure of the parabolic dish-shaped mirror is joined, in turn, with a tracking manipulator shown schematically.

In such a way, a sunlight receiver of the proposed CSP module is the external end butt of the distal plug with its sunlight absorbing coating and the focal spot of the parabolic dish-shaped mirror is mostly overlapped by this sunlight receiver.

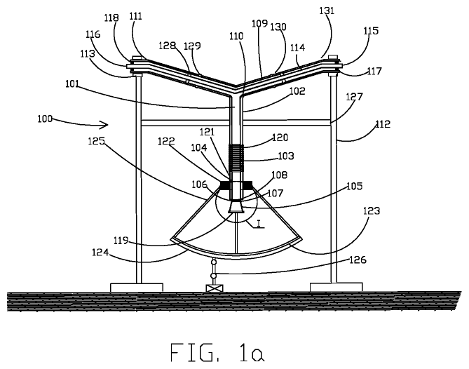

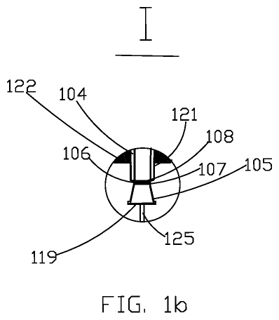

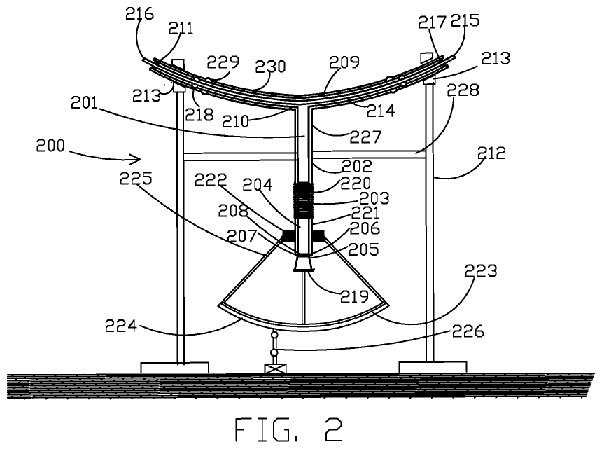

FIG. 1b shows an enlarged axil cross-section of the two-phase thermosiphon at its distal part with the sunlight absorbing coating, which covers the external end butt of the distal plug.

FIG. 2 shows a CSP module comprising a two-phase thermosiphon with its lower section designed like the lower section of the two-phase thermosiphon in FIG. 1a.

The upper section of the two-phase thermosiphon comprises an upper pipe having concave axis, and a heat exchanging pipe of a smaller diameter; the heat exchanging pipe has a concave axis too and is situated coaxially in the internal space of the upper pipe; the terminal sections of this heat exchanging pipe with its inlet and outlet connections are protruded from the upper pipe and the ends of the upper pipe are sealingly joined with the proximal sub-sections of the heat exchanging pipe (the distal section of the heat exchanging heat pipe is its section near the 3-way connector).

A metal vacuum insulated jacket surrounds the two-phase thermosiphon.

There is a bushing, which is fastened on the distal sub-section of the lower section of the metal vacuum insulated jacket; this bushing serves, in turn, for installation of the supporting structure of the parabolic dish-shaped mirror; the supporting structure of the parabolic dish-shaped mirror is joined with a tracking manipulator (shown schematically).

### DETAILED DESCRIPTION OF THE INVENTION

FIG. 1a shows a concentrating solar power module (CSP module), which comprises a two-phase thermosiphon (its axial cross-section) serving for transportation of heat generated on a coating, which absorbs concentrated sunlight; this coating covers the external end butt of a distal plug sealing the lower section of the two-phase thermosiphon.

The proximal sub-section of the lower section of the two-phase thermosiphon is in fluid communication via a 3-way connector with two inclined upper sections of the two-phase thermosiphon; these inclined upper sections are designed as two inclined pipes; the proximal ends of these inclined upper sections are sealed.

A heat exchanging member, which is designed as a heat exchanging pipe, is positioned in the internal space of two inclined upper sections and the 3-way connector of the two-phase thermosiphon; inlet and outlet connection of the heat exchanging pipe are protruded from the sealings of the proximal ends of the inclined upper sections of the two-phase thermosiphon.

A metal vacuum insulating jacket surrounds the two-phase thermosiphon.

A glazing is installed on the flanging of the lower aperture of the metal funnel.

The lower section of the vacuum insulated jacket of the two-phase thermosiphon is joined via a bushing fastened on it with a supporting structure of a parabolic dish-shaped mirror. This supporting structure is joined, in turn, with a tracking manipulator shown schematically.

In such a way, a sunlight receiver of the proposed CSP module is the external end butt of the distal plug with its sunlight absorbing coating, and the focal spot of the parabolic dish-shaped mirror is mostly overlapped by this sunlight receiver.

The CSP module comprises: a two-phase thermosiphon 100; its lower section includes, in turn, an upper sub-section 101, bellows 103, a distal sub-section 104, which is terminated with a metal funnel 105; this distal sub-section 104 is sealed by a distal plug 106; a sunlight absorbing coating 107 covers the external end butt of this distal plug 106 and its internal end butt is covered with a capillary coating 108.

There are two inclined upper sections 109 of the two-phase thermosiphon 100; these upper inclined sections 109 are in fluid communication with the lower section of the two-phase thermosiphon 100 via a 3-way connector 110.

A heat exchanging member, which is designed as a heat exchanging pipe 114, is positioned in the internal space of two inclined upper sections 109 and the 3-way connector 110 of the two-phase thermosiphon 100; inlet and outlet connections 115 and 116 of the heat exchanging pipe 114 are protruded from plugs 117 and 118.

A metal vacuum insulated jacket 102 surrounds the walls (including the 3-way connector 110) of the two-phase thermosiphon 100.

Glazing 119 is installed on the flanging of the metal funnel 105.

There is an additional bellows 120 of the metal vacuum insulated jacket 102, which surrounds bellows 103 of the lower section of the two-phase thermosiphon 100.

Bushing 122 is installed on the distal sub-section 121 of the metal vacuum insulated jacket 102; this bushing 122 serves for installation of a parabolic dish-shaped mirror 123; a supporting structure 124 of the parabolic dish-shaped mirror 123 is joined with bushing 122 by truss struts 125.

A tracking manipulator 126 is joined with the supporting structure 124 of the parabolic dish-shaped mirror 123 at a certain point of the supporting structure 124.

An upper sub-section 127 of the lower section of the metal vacuum insulated jacket 102 is joined by cross-bar 128 with posts 112; it provides mechanical rigidity to the upper sub-section 127 of the lower section of the metal vacuum insulated jacket 102.

The proximal sub-sections 111 of the upper inclined pipes 109 of the two-phase thermosiphon 100 are sealed with plugs 117 and 118.

The proximal sub-sections 131 of upper sections 130 of the metal vacuum insulated jacket 102 are supported by supporting members 113 installed on posts 112.

The upper inclined sections 130 of the metal vacuum insulated jacket 102 and the inclined upper sections 109 are provided with auxiliary bellows 129 and 128.

FIG. 1b shows a detailed axil cross-section of the two-phase thermosiphon 100 with the metal vacuum insulated jacket 102 at their distal parts.

It comprises the distal sub-section 104 of the lower section of the two-phase thermosiphon 100, which is terminated with the metal funnel 105; the distal sub-section 104 is sealed by the distal plug 106; the sunlight absorbing coating 107 covers the external end butt of this distal plug 106 and its internal end butt is covered by a capillary coating 108.

The distal sub-section 121 of the lower section of the metal vacuum insulated jacket 102 serves for installation of bushing 122, which is joined with the truss strut 125.

FIG. 2 shows a CSP module comprising a two-phase thermosiphon with its lower section designed like the lower section of the two-phase thermosiphon in FIG. 1a.

The CSP module comprises: a two-phase thermosiphon 200 with a lower section including, in turn, an upper sub-section 201, bellows 203, a distal sub-section 204, which is terminated with a metal funnel 205; this distal sub-section 204 is sealed by a distal plug 206; a sunlight absorbing coating 207 covers the external end butt of this distal plug 206 and its internal end butt is covered by a capillary coating 208.

The upper section of the two-phase thermosiphon comprises an upper pipe 209 having concave axis, and a heat exchanging pipe 214 of smaller diameter; the heat exchanging pipe 214 has a concave axis too and is situated coaxially in the internal space of the upper pipe 209; the terminal sections of this heat exchanging pipe 214 with its inlet and outlet connections are protruded from the upper pipe and the ends of the upper pipe are sealed with the proximal sub-sections of the heat exchanging pipe.

The upper section 209 of the two-phase thermosiphon 200 is in fluid communication with the lower section of the two-phase thermosiphon 200 via a 3-way connector; this 3-way connector has an upper concave axis, which fits the concave axis of the upper section 209.

Glazing 219 is installed on the flanging of the metal funnel 205.

A metal vacuum insulated jacket 202 surrounds the walls of the two-phase thermosiphon 200 (including the 3-way connector 210).

There is an additional bellows 220 of the metal vacuum insulated jacket 202, which surrounds bellows 203 of the lower section of the two-phase thermosiphon 200.

Bushing 222 is installed on a distal sub-section 221 of the metal vacuum insulated jacket 202; this bushing 222 is joined with a supporting structure 224 of a parabolic dish-shaped mirror 223 by truss struts 225.

A tracking manipulator 226 is joined with the supporting structure 224 of the parabolic dish-shaped mirror 223 at a certain point of the supporting structure 224.

An upper sub-section 227 of the lower section of the metal vacuum insulated jacket 202 is joined by cross-bar 228 with posts 212; it provides mechanical rigidity to the upper sub-section 227 of the lower section of the metal vacuum insulated jacket 202.

The proximal sub-sections of the upper concave section 209 of the two-phase thermosiphon 200 are sealed with plugs 211 and 217; these proximal sub-sections with the terminal sections of the metal vacuum insulated jacket 202 are supported by supporting members 213 installed on posts 212.

Inlet and outlet connections 215 and 216 of pipe 214 are protruded from plugs 211 and 217.

The upper concave section 230 of the metal vacuum insulated jacket 202 and the concave upper section 209 are provided with auxiliary bellows 229 and 218.

1. A concentrating solar power (CSP) module comprising following elements and units:
a two-phase thermosiphon intended to transport heat generated by concentrated sunlight on a sunlight receiving member to the external surface of a heat exchanging pipe with heat transfer fluid; said two-phase thermosiphon comprises a lower section, which is divided, in turn, in a distal sub-section in the form of a pipe sealed at its lower end with a plug, an middle sub-section in the form of a bellows and a proximal sub-section in the form of a pipe;
the external surface of the end butt of said plug is provided with an external sunlight absorbing coating playing a role of said sunlight receiving member;
an upper section of said two-phase thermosiphon is designed as two inclined pipe, which are in flow communication at their distal sub-sections and via a 3-way connector with said proximal sub-section of said lower section of said two-phase thermosiphon; said heat exchanging pipe is positioned in said inclined pipes and said 3-way connector; the proximal sections of said heat exchanging pipe are protruded from said inclined pipes of said upper section; the proximal ends of said inclined pipes are sealingly joined with said heat exchanging pipe; said proximal protruded sections of said heat exchanging pipe are terminated by inlet and outlet connections; a metal vacuum insulated jacket surrounds the wall of said two-phase thermosiphon and said metal vacuum insulated jacket is divided in sections and sub-sections corresponded to said sections and sub-sections of said two-phase thermosiphon; the middle sub-section of the lower section of said metal vacuum insulated jacket is an additional bellows which is situated around said bellows of said lower section of said two-phase thermosiphon;
two posts are provided with supporting members, which support the proximal sub-sections of said upper section of said metal vacuum insulated jacket;
a metal funnel with a flanging on its lower edge is installed on said distal sub-section of said lower section of said two-phase thermosiphon;
a glazing is installed on said flanging of said metal funnel;
a bushing, which is fastened on said distal sub-section of said lower section of said metal vacuum insulated jacket;
parabolic dish-shaped mirror and its supporting structure are positioned below said metal funnel; said bushing is joined by truss struts with said supporting structure of said parabolic dish-shaped mirror;
a tracking manipulator, which is joined with said supporting structure of said parabolic dish-shaped mirror; said tracking manipulator provides orientation of the axis of said parabolic dish-shaped mirror and, therefore, of the axis of said distal sub-section of said lower section of said two-phase thermosiphon and said distal sub-section of lower section of said metal vacuum insulated jacket towards the sun.

2. The concentrating solar power (CSP) module as claimed in claim 1, wherein the metal funnel is provided on its outer surface with a layer of thermal insulation.

3. The concentrating solar power (CSP) module as claimed in claim 1, wherein the inter surface of the metal funnel has a high reflectance coefficient for sunlight.

4. The concentrating solar power (CSP) module as claimed in claim 1, wherein the heat exchanging pipes are provided with longitudinal internal ribs.

5. The concentrating solar power (CSP) module as claimed in claim 1, wherein alkali metal is used as working medium of the two-phase thermosiphon.

6. The concentrating solar power (CSP) module as claimed in claim 1, wherein water is used as working medium of the two-phase thermosiphon.

7. The concentrating solar power (CSP) module as claimed in claim 1, wherein dowtherm A is used as working medium of the two-phase thermosiphon.

8. The concentrating solar power (CSP) module as claimed in claim 1, wherein metal halide is used as working medium of the two-phase thermosiphon.

9. The concentrating solar power (CSP) module as claimed in claim 1, wherein the upper sub-section of the lower section of the metal vacuum insulated jacket is joined by a cross-bar with the posts.

10. The concentrating solar power (CSP) module as claimed in claim 1, wherein the upper inclined sections of the metal vacuum insulated jacket and/or the inclined pipes of the upper sections of the two-phase thermosiphon are provided with auxiliary bellows.

11. The concentrating solar power (CSP) module as claimed in claim 1, wherein the space between the walls of the two-phase thermosiphon and the metal vacuum insulated jacket is filled with fibers, microporous materials or refractories.

12. The concentrating solar power (CSP) module as claimed in claim 1, wherein the outer surfaces of the bellows of the two-phase thermosiphon and/or the additional bellows of the metal vacuum insulated jacket are protected by braids.

13. The concentrating solar power (CSP) module as claimed in claim 1, wherein a significant part of the heat exchanging pipe is helically coiled.

14. The concentrating solar power (CSP) module as claimed in claim 1, wherein the upper section of the two-phase thermosiphon comprises an upper pipe having concave axis, and a heat exchanging pipe has a concave axis too and is situated coaxially in the internal space of the upper section of said two-phase thermosiphon; the terminal sections of said heat exchanging pipe with its inlet and outlet connections are protruded from said upper pipe of said two-phase thermosiphon; the ends of said upper pipe are sealingly joined with the proximal sections of said heat exchanging pipe;
the metal vacuum insulated jacket surrounds the walls of said two-phase thermosiphon; the terminal sub-sections of the upper section of the metal vacuum insulated jacket are supported by the supporting member installed on the posts.
